(19) United States
(12) Patent Application Publication
(10) Pub. No.: US 2007/0279385 A1
(43) Pub. Date: Dec. 6, 2007

(54) CAPACITANCE SENSING TOUCHPAD CIRCUIT CAPABLE OF DUAL USE AS A TOUCHPAD CONTROLLER AND KEYBOARD CONTROLLER

(76) Inventors: Richard D. Woolley, Orem, UT (US); Paul Vincent, Fruit Heights, UT (US); Daniel Joseph Lee, Salt Lake City, UT (US)

Correspondence Address: MORRISS OBRYANT COMPAGNI, P.C., 734 EAST 200 SOUTH, SALT LAKE CITY, UT, 84102, US

(21) Appl. No.: 11/692,742

(22) Filed: Mar. 28, 2007

Related U.S. Application Data
(60) Provisional application No. 60/786,816, filed on Mar. 28, 2006.

(51) Int. Cl. G09F 3/02

(52) U.S. Cl. 345/168

(57) ABSTRACT

Touchpad sensor control circuitry that controls the operation of a touch or proximity sensitive touchpad in a first mode, and in a second mode functions as a keyboard controller, wherein the touchpad sensor control circuitry also determines which keys on a keyboard have been actuated by manipulation of keys, wherein pressing a key is detected by the touchpad sensor control circuitry.

### CROSS REFERENCE TO RELATED APPLICATIONS

This document claims priority to and incorporates by reference all of the subject matter included in the provisional patent application docket number 3589.CIRQ.PR, having Ser. No. 60/786,816 and filed on 03/38/2006.

### BACKGROUND OF THE INVENTION

1. Field of the Invention

This invention relates generally to keyboards and capacitance sensitive touchpads.

2. Description of Related Art

An important aspect of the present invention is the use of capacitance sensing touchpad technology. It has been determined that control circuitry that sends and receives signals from a sensor grid of electrodes for use in a touch or proximity capacitance sensitive touchpad can be used to operate more than just a touchpad.

To understand how to adapt existing touchpad technology to provide new capabilities, it is important to understand operation of a capacitance sensitive touchpad in order to understand how the control circuitry can be adapted to operate in the present invention. Touchpad technology of CIRQUE® Corporation can be adapted as described later in this document to perform the desired functions of the present invention.

The CIRQUE™ Corporation touchpad is a mutual capacitance-sensing device and an example is illustrated in FIG. 1. In this touchpad, a grid of row and column electrodes is used to define the touch-sensitive area of the touchpad. Typically, the touchpad is a rectangular grid of approximately 16 by 12 electrodes, or 8 by 6 electrodes when there are space constraints. Interlaced with these row and column electrodes is a single sense electrode. All position measurements are made through the sense electrode.

In more detail, FIG. 1 shows a capacitance sensitive touchpad 10 as taught by Cirque® Corporation includes a grid of row (12) and column (14) (or X and Y) electrodes in a touchpad electrode grid. All measurements of touchpad parameters are taken from a single sense electrode 16 also disposed on the touchpad electrode grid, and not from the X or Y electrodes 12, 14. No fixed reference point is used for measurements. Touchpad sensor control circuitry 20 generates signals from P,N generators 22, 24 that are sent directly to the X and Y electrodes 12, 14 in various patterns. Accordingly, there is a one-to-one correspondence between the number of electrodes on the touchpad electrode grid, and the number of drive pins on the touchpad sensor control circuitry 20.

The touchpad 10 does not depend upon an absolute capacitive measurement to determine the location of a finger (or other capacitive object) on the touchpad surface. The touchpad 10 measures an imbalance in electrical charge to the sense line 16. When no pointing object is on the touchpad 10, the touchpad sensor control circuitry 20 is in a balanced state, and there is no signal on the sense line 16. There may or may not be a capacitive charge on the electrodes 12, 14. In the methodology of CIRQUE® Corporation, that is irrelevant. When a pointing device creates imbalance because of capacitive coupling, a change in capacitance occurs on the plurality of electrodes 12, 14 that comprise the touchpad electrode grid. What is measured is the change in capacitance, and not the absolute capacitance value on the electrodes 12, 14. The touchpad 10 determines the change in capacitance by measuring the amount of charge that must be injected onto the sense line 16 to reestablish or regain balance on the sense line.

The touchpad 10 must make two complete measurement cycles for the X electrodes 12 and for the Y electrodes 14 (four complete measurements) in order to determine the position of a pointing object such as a finger. The steps are as follows for both the X 12 and the Y 14 electrodes:

First, a group of electrodes (say a select group of the X electrodes 12) are driven with a first signal from P, N generator 22 and a first measurement using mutual capacitance measurement device 26 is taken to determine the location of the largest signal. However, it is not possible from this one measurement to know whether the finger is on one side or the other of the closest electrode to the largest signal.

Next, shifting by one electrode to one side of the closest electrode, the group of electrodes is again driven with a signal. In other words, the electrode immediately to the one side of the group is added, while the electrode on the opposite side of the original group is no longer driven.

Third, the new group of electrodes is driven and a second measurement is taken.

Finally, using an equation that compares the magnitude of the two signals measured, the location of the finger is determined.

Accordingly, the touchpad 10 measures a change in capacitance in order to determine the location of a finger. All of this hardware and the methodology described above assume that the touchpad sensor control circuitry 20 is directly driving the electrodes 12, 14 of the touchpad 10. Thus, for a typical 12×16 electrode grid touchpad, there are a total of 28 pins (12+16=28) available from the touchpad sensor control circuitry 20 that are used to drive the electrodes 12, 14 of the electrode grid.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes on the same rows and columns, and other factors that are not material to the present invention.

Although the CIRQUE® touchpad described above uses a grid of X and Y electrodes and a separate and single sense electrode, the sense electrode can also be the X or Y electrodes by using multiplexing. Either design will enable the present invention to function.

Touchpads are now often disposed adjacent to keyboards in laptops and desktop configurations. The touchpad and the keyboard each require separate control circuitry that controls the operation and function of each system.

Accordingly, it would be an advantage over the state of the art to utilize the touchpad sensor control circuitry 20 to not only control operation of a touchpad, but to also control operation of the keyboard, thereby reducing circuitry required to operate both systems.

### BRIEF SUMMARY OF THE INVENTION

It is an object of the present invention to provide touchpad sensor control circuitry that can control a capacitance sensitive touchpad and function as a keyboard controller.

In a preferred embodiment, the present invention is touchpad sensor control circuitry that controls the operation of a touch or proximity sensitive touchpad in a first mode, and in a second mode functions as a keyboard controller, wherein the touchpad sensor control circuitry also determines which keys on a keyboard have been actuated by manipulation of keyboard keys, wherein pressing a keyboard key is detected by the touchpad sensor control circuitry.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective diagram of the components of a capacitance-sensitive touchpad as made by CIRQUE® Corporation.

FIG. 2 is a block diagram that illustrates the touchpad control circuitry, the touchpad, the keyboard, the X and Y electrodes, and the sense electrode.

FIG. 3 is a close-up view of an intersection of X and Y electrodes underneath a key, and the sense electrode that is a mere point where it has punched through a substrate to be near the point of intersection.

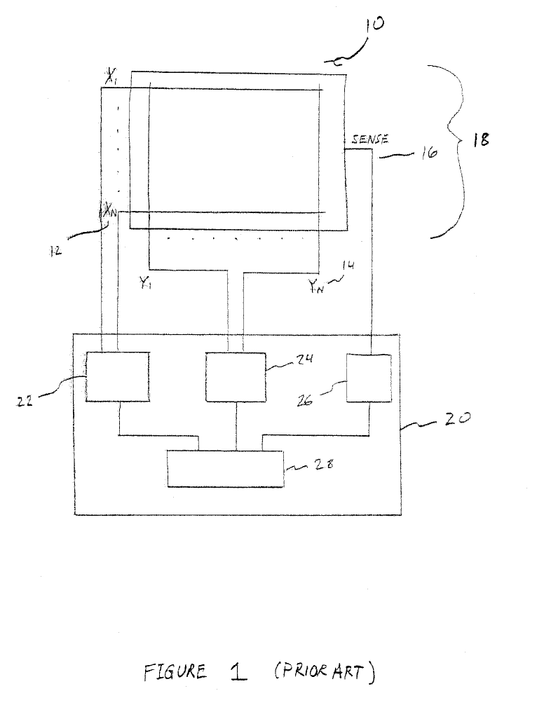

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

There are several different embodiments of the invention that will be described herein. Each embodiment may have unique advantages and disadvantages as compared to the others.

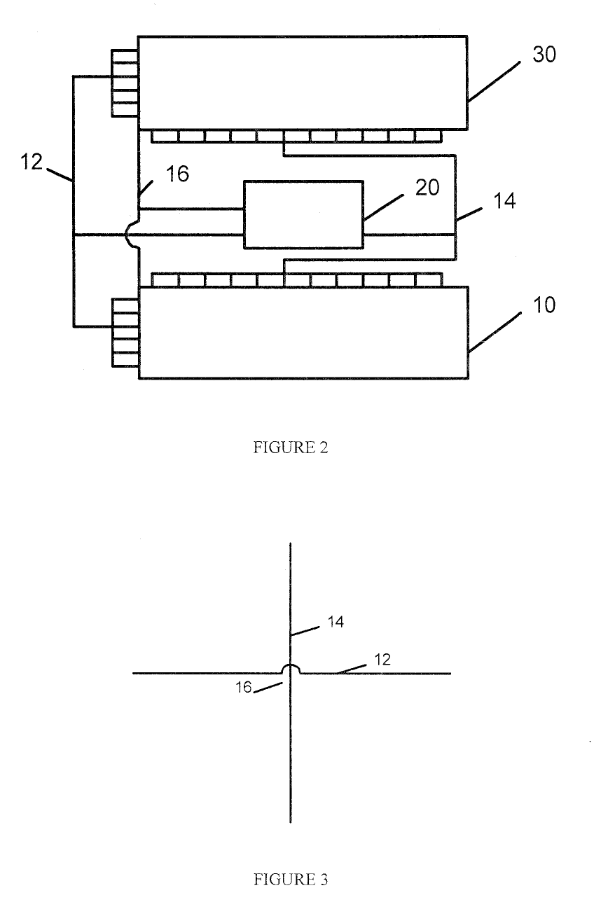

In a first embodiment of the present invention as shown in FIG. 2, a touchpad 10 and a keyboard 30 are both active at the same time. In other words, a user can use the keyboard 30 while simultaneously operating the touchpad 10. This mode of simultaneous operation is possible because the touchpad sensor control circuitry 20 is operating in a typical capacitive mode. But it should also be realized that because the keyboard 30 and the touchpad 10 are both active, this embodiment draws more power than an alternative embodiment yet to be described.

In this capacitive mode of operation, touchpad sensor control circuitry 20 is coupled to the touchpad 10 via a grid of electrodes 12, 14, wherein a first set of electrodes 12 are configured as X electrodes, and wherein a second set of electrodes 14 are configured as Y electrodes. All measurements of touchpad 10 parameters are taken from a single sense electrode 16, and not from the sets of X or Y electrodes 12, 14.

In this embodiment, the sense electrode is not disposed in the same layers as the X and Y electrodes 12, 14. Instead, the sense electrode 16 is electrically isolated from the X and Y electrodes 12, 14. The sense electrode 16 is punched through a circuit board or other substrate material where the X and Y electrodes 12, 14 are disposed. More specifically, an aperture or hole 18 is created near each intersection of the X and Y electrodes 12, 14. The sense electrode 16 is pushed through each hole 18 sufficient for the mutual capacitance between the sense electrode and the X and Y electrodes 12, 14 to be changed by the approach of a keyboard key 34.

The change in mutual capacitance that can be caused by the key 34 of the keyboard 30 is a result of a material disposed, for example, on a bottom surface of the key. The key 34 can have some material disposed thereunder that is able to affect the mutual capacitance, just as a human finger can also affect the mutual capacitance.

In this first embodiment, it is shown in FIG. 3 that the sets of X and Y electrodes 12, 14 are also arranged as a grid 32 that is disposed beneath the keys of a keyboard 30. The keyboard 30 has a plurality of keys arranged in any desired pattern. For example, the keyboard 30 may have keys arranged in the ubiquitous QWERTY arrangement. However, this arrangement is arbitrarily selected. The keyboard 30 can have any number of keys arranged in any desired pattern. What is important is that the keys are disposed above the grid 32. The grid 32 must be arranged so that the sets of X and Y electrodes 12, 14 intersect underneath the keys of the keyboard 30. When any key 34 of the keyboard 30 is pressed, the mutual capacitance between the X and Y electrodes 12, 14 and the sense electrode 16 beneath that key will be changed, and that change in capacitance is detected by the touchpad sensor control circuitry 20.

FIG. 3 is a close-up of the intersection of an X and Y electrode 12, 14. This figure shows that the sense electrode 16 has been punched through so as to be near the point of intersection 34 of the electrodes 12, 14. It should be realized that a “punch-through” is not the only way of enabling the sensor to detect the change in capacitance on the electrodes. For example, a conductive post or other material can also be disposed through an insulating material to enable the sensor electrode 16 to detect the change in capacitance.

The situation described above wherein keys of a keyboard 30 cause a change in mutual capacitance between X and Y electrodes 12, 14 and the sense electrode 16 enables the touchpad 10 to also continue functioning because the keyboard and the touchpad are both using the same principle of operation. In other words, the touchpad 10 and the keyboard 30 can operate simultaneously.

A second embodiment of the present invention may be considered to be a low power mode embodiment because the touchpad 10 and the keyboard 30 will not be functioning at the same time. More specifically, the touchpad 10 and the keyboard 30 will not be able to function at the same time.

In this alternative embodiment, the touchpad 10 operates in its typical mutual capacitance mode of operation as described above. In contrast, the keyboard 30 operates in a mode that can be described as a simple switch.

Consider the X and Y electrodes 12, 14 again arranged as a grid of perpendicular electrodes that are disposed in a co-planar arrangement as in the first embodiment. However, in this alternative embodiment, there is no sense electrode present. Instead, one of the electrodes has a “high” signal disposed thereon, and the other grid has a “low” or ground signal disposed thereon. When a key 34 is pressed, the key causes a short circuit at an intersection between an X and Y electrode 12, 14. The touchpad sensor control circuitry 20 is capable of determining where the short circuit between the X and Y electrodes 12, 14 has taken place through calculations known to those skilled in the art. Thus, the touchpad sensor control circuitry 20 can generate a signal that represents the key 34 that has been pressed once the touchpad sensor control circuitry determines where the X and Y electrodes 12, 14 have been short circuited underneath the keyboard 30.

The act of causing the short circuit can be accomplished, for example, by providing an electrically conductive path between the X and Y electrodes 12, 14 at any intersection. The electrically conductive path may be as simple as providing a flat and conductive surface on the bottom of the keys of the keyboard 30. Pressing a key 34 down on the X and Y electrodes 12, 14 serves to complete the path between the electrodes.

In this resistive mode of keyboard 30 operation, it should be apparent that the touchpad sensor control circuitry 20 as made by CIRQUE™ Corporation can only operate as a touchpad controller or as a keyboard controller, but not both at the same time. Thus, if the touchpad sensor control circuitry 20 is detecting a touchdown on the touchpad 10 or tracking movement of an object on or in proximity to a touchpad surface, the keyboard 30 function will be inactive, and the touchpad sensor control circuitry will not detect a short circuit between X and Y electrodes 12, 14 underneath the keyboard 30. Likewise, if the touchpad sensor control circuitry 20 is being used to detect short circuits between the X and Y electrodes 12, 14 underneath the keyboard 30, the touchpad sensor control circuitry will not be capable of also detecting a touchdown or tracking movement of an object on or in proximity to the touchpad surface in a capacitive mode of operation, and thus the touchpad will be inactive.

It is envisioned that the second embodiment will employ manual and automatic means for switching between the different devices. Thus, use of the touchpad 10 or the keyboard 30 may activate that component automatically, or it may be necessary to actuate a switch in order to change which of the two devices is active and ready for operation.

The third embodiment of the present invention is related to the first embodiment in that the touchpad sensor control circuitry 20 is operating in a typical capacitive mode and using the sense line 16. Such a configuration is described in co-pending patent application Ser. No. 10/634,738, wherein it is taught how electrodes and a sense line enable the detection of an object in “zones” of a touchpad.

The sense line 16 is disposed throughout the grid of X and Y electrodes 12, 14. The operation of the keyboard uses a sequential scanning scheme. For example, the X and Y electrodes 12, 14 are driven separately so that there is only one intersection of the electrodes where both the X and Y electrodes are active. Then the sense line is sampled to determine if the specific intersection of the active X and Y electrodes 12, 14 is causing mutual capacitance between the X and Y electrodes 12, 14 and the sense line 16 to be changed. If no change in mutual capacitance is detected, then the active electrodes 12, 14 are changed so that another intersection is active, and the sense line 16 is again sampled. This process can be performed very rapidly, even if there are more than 100 intersections to be sampled. In many modern keyboards, there are often more than 100 keys, so this is not a limitation of this method.

It is noted that the keys of the keyboard 30 are again enabled to cause a change in mutual capacitance, and not to create short circuits between the X and Y electrodes 12, 14.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A single system for controlling operation of a touchpad and a keyboard, said system comprised of:
a touchpad sensor control circuit that is coupled to a first set of X and Y electrodes operating as touchpad sensors and disposed within a touchpad;
the touchpad sensor control circuit that is also coupled to a second set of X and Y electrodes operating as keyboard key sensors and disposed within a keyboard; and
wherein the touchpad sensor control circuit controls operation of the touchpad in a first mode, and wherein the touchpad sensor control circuit controls operation of the keyboard in a second mode.

2. The system as defined in claim 1 wherein the touchpad and the keyboard are operated simultaneously by operating the touchpad and the keyboard in a capacitive detection mode of operation.

3. The system as defined in claim 2 wherein the touchpad and the keyboard are both active, and operating in a high power mode, wherein the touchpad and the keyboard are capable of simultaneous operation.

4. The system as defined in claim 3 wherein the system is further comprised of a sense line disposed so as to be capable of detecting a signal from the first set and the second set of X and Y electrodes.

5. The system as defined in claim 4 wherein the system is further comprised of:
a first insulator between the first set of X and Y electrodes and the sense line, and a second insulator between the second set of X and Y electrodes and the sense line; and
a plurality of conductive posts that are disposed through the first insulator and the second insulator that enable the sense line to detect changes in capacitance on the first set and the second set of X and Y electrodes.

6. The system as defined in claim 1 wherein the touchpad and the keyboard do not function simultaneously because the touchpad is operating in a capacitive mode of operation, and the keyboard is operating in a resistive mode of operation.

7. The system as defined in claim 6 wherein the touchpad and the keyboard are operating in a low power mode of operation because either the touchpad or the keyboard is active at any one time, but not both.

8. A single system for controlling operation of a touchpad and a keyboard, said system comprised of:
a touchpad sensor control circuit that is coupled to a first set of X and Y electrodes disposed within a touchpad;
a single sense line disposed within the touchpad;
the touchpad sensor control circuit that is coupled to a second set of X electrodes disposed within a keyboard;
the single sense line also disposed within the keyboard;
wherein the touchpad sensor control circuit controls operation of the touchpad in a first mode, and wherein the touchpad sensor control circuit controls operation of the keyboard in a second mode.

9. The system as defined in claim 8 wherein the touchpad and the keyboard are operated as capacitance sensitive devices.

10. A method for controlling operation of a touchpad and a keyboard using a single touchpad controller, said method comprising the steps of:
(1) providing a touchpad sensor control circuit that is coupled to a first set of X and Y electrodes operating as touchpad sensors and disposed within a touchpad, coupling a second set of X and Y electrodes to the touchpad sensor control circuit and operating as keyboard key sensors disposed within a keyboard;
(2) controlling operation of the touchpad in a first mode; and
(3) controlling operation of the keyboard in a second mode.

11. The method as defined in claim 10 wherein the method further comprises the step of operating the touchpad and the keyboard simultaneously by operating the touchpad and the keyboard in a capacitive detection mode of operation.

12. The method as defined in claim 11 wherein the method further comprises the step of operating the touchpad and the keyboard in a high power mode, wherein the touchpad and the keyboard are capable of simultaneous operation.

13. The method as defined in claim 10 wherein the method further comprises the step of operating the touchpad and the keyboard exclusively of each other by operating the touchpad in a capacitive mode of operation, and operating the keyboard in a resistive mode of operation.

14. The method as defined in claim 13 wherein the method further comprises the step of operating the touchpad and the keyboard in a low power mode of operation because either the touchpad or the keyboard is active at any one time, but not both.

15. A method for controlling operation of a touchpad and a keyboard, said method comprising the steps of:
(1) providing a touchpad sensor control circuit that is coupled to a first set of X and Y electrodes and to a second set of X electrodes disposed within a keyboard, and a single sense line disposed so as to be able to detect signals from the first and the second set of X and Y electrodes;
(2) operating the touchpad in a first mode; and
(3) operating the keyboard in a second.

16. The method as defined in claim 15 wherein the method further comprises the step operating the touchpad and the keyboard as capacitance sensitive devices.
